(19) United States
(12) Patent Application Publication
(10) Pub. No.: US 2021/0287208 A1
(43) Pub. Date: Sep. 16, 2021

(54) MOBILE TERMINAL, COMPUTER READABLE RECORDING MEDIUM AND WALLET SYSTEM

(71) Applicant: TOYOTA JIDOSHA KABUSHIKI KAISHA, Toyota-shi (JP)

(72) Inventors: Hiroto TOMIDA, Tokyo (JP); Tae SUGIMURA, Miyoshi-shi (JP); Ryuta YANAGISAWA, Ichikawa-shi (JP); Takuya TORIU, Tokyo (JP); Daisuke KOMIYAMA, Tokyo (JP); Zejun MEI, Fujimi-shi (JP); Kazuhiko YAMAGUCHI, Nagoya-shi (JP); Honami MORI, Nagoya-shi (JP)

(73) Assignee: TOYOTA JIDOSHA KABUSHIKI KAISHA, Toyota-shi (JP)

(21) Appl. No.: 17/164,153

(22) Filed: Feb. 1, 2021

(30) Foreign Application Priority Data
Mar. 16, 2020 (JP) 2020-045550

(51) Int. Cl. G06Q 20/36; G06Q 20/40; G06Q 20/10

(52) U.S. Cl. CPC G06Q 20/3676; G06Q 20/108; G06Q 20/405

(57) ABSTRACT

A mobile terminal includes: a display; and a processor including hardware, the processor being configured to acquire, when electronic money is deposited into a first electronic wallet from a first bank account registered in advance, information regarding a future scheduled withdrawal amount in the first bank account from a server managing the first bank account, and control the display to display alert information when a balance after withdrawal obtained by subtracting the scheduled withdrawal amount from a current balance of the first bank account is less than a scheduled deposit amount indicating an amount of electronic money to be deposited from the first bank account.

The present application claims priority to and incorporates by reference the entire contents of Japanese Patent Application No. 2020-045550 filed in Japan on Mar. 16, 2020.

### BACKGROUND

The present disclosure relates to a mobile terminal, a computer readable recording medium and a wallet system.

JP 2006-114003 A discloses a system that automatically determines, in accordance with transfer processing conditions, a transfer source account with a lowest transfer fee from among a plurality of accounts held by a transfer requester.

### SUMMARY

There is a need for a for a mobile terminal, a computer readable recording medium and a wallet system capable of improving user convenience not only in a case of handling cash but also in a case of handling electronic money which is an electronic settlement method.

According to one aspect of the present disclosure, there is provided a mobile terminal includes: a display; and a processor including hardware, the processor being configured to acquire, when electronic money is deposited into a first electronic wallet from a first bank account registered in advance, information regarding a future scheduled withdrawal amount in the first bank account from a server managing the first bank account, and control the display to display alert information when a balance after withdrawal obtained by subtracting the scheduled withdrawal amount from a current balance of the first bank account is less than a scheduled deposit amount indicating an amount of electronic money to be deposited from the first bank account.

### BRIEF DESCRIPTION OF THE DRAWINGS

FIG. 1 is a diagram schematically illustrating a configuration of a wallet system according to an embodiment;

FIG. 2 is a block diagram illustrating details of each component of the wallet system according to the embodiment;

FIG. 3 is a diagram illustrating an example of alert information displayed on a user terminal in the wallet system according to the embodiment; and

FIG. 4 is a flowchart illustrating an example of a method of charging electronic money executed by the wallet system according to the embodiment.

### DETAILED DESCRIPTION

A mobile terminal, a computer readable recording medium storing a wallet program, and a wallet system according to an embodiment will be described with reference to the drawings. Note that components in the following embodiment include those which may be easily replaced by a person skilled in the art, or those which are substantially the same.

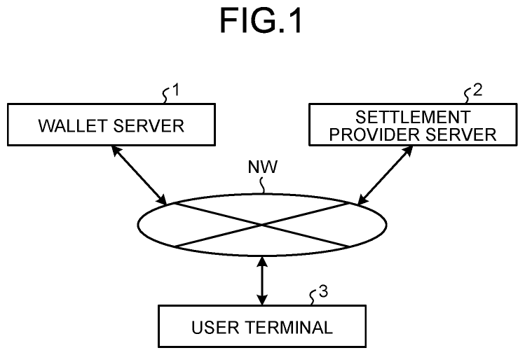

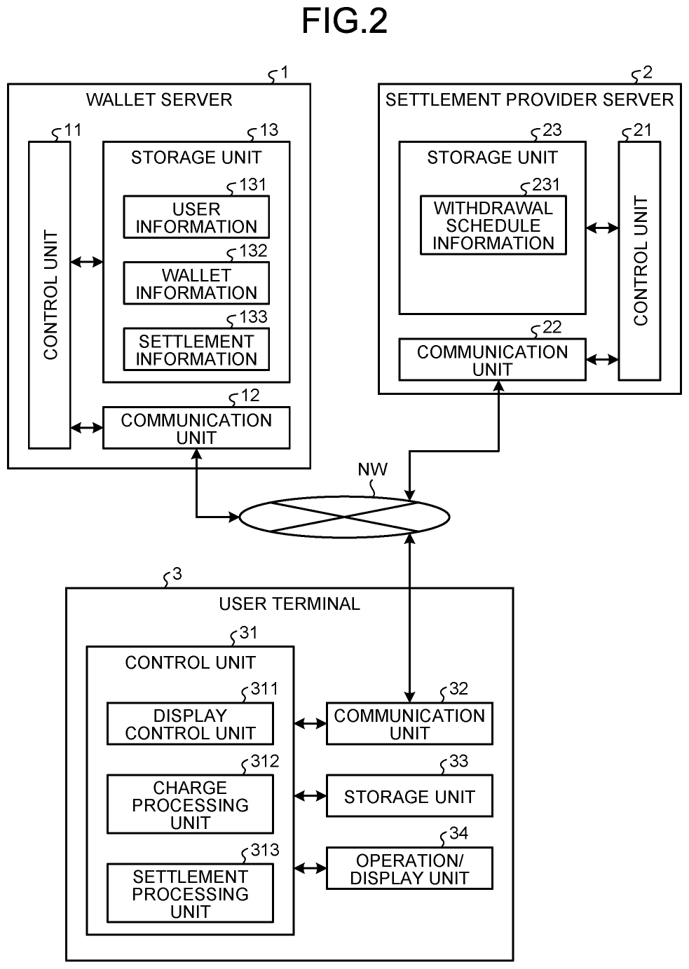

A configuration of the wallet system according to the embodiment will be described with reference to FIGS. 1 and 2. As illustrated in FIG. 1, the wallet system includes a wallet server 1, a settlement provider server 2, and a user terminal 3. In the wallet system, the wallet server 1, the settlement provider server 2, and the user terminal 3 may communicate with each other through a network NW. The network NW includes, for example, an internet line network and a mobile phone line network. Note that, although only one settlement provider server 2 and only one user terminal 3 are illustrated in FIG. 1, there may be a plurality of the settlement provider servers 2 and a plurality of the user terminals 3.

The wallet server 1 is a server for managing the wallet system according to the embodiment. This wallet server 1 is implemented by a general-purpose computer such as a workstation or a personal computer. In addition, the wallet server 1 is managed by an administrator (provider) of the wallet system. As illustrated in FIG. 2, the wallet server 1 includes a control unit 11, a communication unit 12, and a storage unit 13.

Specifically, the control unit 11 includes a processor including a central processing unit (CPU), a digital signal processor (DSP), and a field-programmable gate array (FPGA), and a memory (main storage unit) including a random access memory (RAM) and a read only memory (ROM). The control unit 11 loads a program stored in the storage unit 13 into a work area of the main storage unit, executes the program, and controls each component and the like through the execution of the program, thereby implementing a function matching a predetermined purpose.

The communication unit 12 includes, for example, a local area network (LAN) interface board and a wireless communication circuit for wireless communication. The communication unit 12 is connected to the network NW such as the Internet serving as a public communication network. In addition, the communication unit 12 communicates with the settlement provider server 2 and the user terminal 3 by connecting to the network NW.

The storage unit 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage unit 13 may store an operating system (OS), various programs, various tables, various databases, and the like. The storage unit 13 also stores user information 131, wallet information 132, and settlement information 133, for each user of the wallet system.

The user information 131 is information regarding a user who uses the wallet system. Examples of the user information 131 includes a user ID of the user who has registered to use the wallet system in advance, a password, a name of the user, and contact information (for example, address, phone number, and email address) of the user. Note that, in the user information 131, the user ID and the password are used for authentication processing such as login to the wallet server 1.

The wallet information 132 is information regarding an electronic wallet (hereinafter, “wallet”) of the wallet system. The wallet indicates a virtual deposit/withdrawal account of electronic money. Examples of the wallet information 132 include a user ID, a balance of electronic money, a charge history of electronic money, and a use history of electronic money.

The settlement information 133 is information regarding settlement of the wallet system. The settlement information 133 includes a user ID, a settlement method used for settlement (for example, electronic money payment (contactless payment), scan payment, and code payment), and a settlement history.

The settlement provider server 2 is a server for managing a bank account and a credit card of the user. This settlement provider server 2 is implemented by a general-purpose computer such as a workstation or a personal computer. In addition, the settlement provider server 2 is managed by, for example, a financial institution (for example, a bank, a credit union, a credit association, and a labor bank) and a credit card company.

As illustrated in FIG. 2, the settlement provider server 2 includes a control unit (first processor) 21, a communication unit 22, and a storage unit 23. The control unit 21, the communication unit 22, and the storage unit 23 are physically similar to the control unit 11, the communication unit 12, and the storage unit 13. The storage unit 23 stores withdrawal schedule information 231.

The withdrawal schedule information 231 is information regarding withdrawal from a bank account registered by the user as a charging method. Examples of the withdrawal schedule information 231 include, for example, a name of a withdrawal source (for example, a credit card company), a withdrawal date, and a scheduled withdrawal amount.

The user terminal 3 is a mobile terminal used by the user. The “user” in the present disclosure refers to a person who uses the wallet system. Through the user terminal 3, the user may deposit (hereinafter referred to as “charge”) electronic money and perform settlement using the electronic money. Examples of the user terminal 3 include a smartphone, a mobile phone, a tablet terminal, and a wearable computer, which are owned by the user.

As illustrated in FIG. 2, the user terminal 3 includes a control unit (second processor) 31, a communication unit 32, a storage unit 33, and an operation/display unit (display) 34. The control unit 31, the communication unit 32, and the storage unit 33 are physically similar to the control unit 11, the communication unit 12, and the storage unit 13. The control unit 31 functions as a display control unit 311, a charge processing unit 312, and a settlement processing unit 313 through execution of a program.

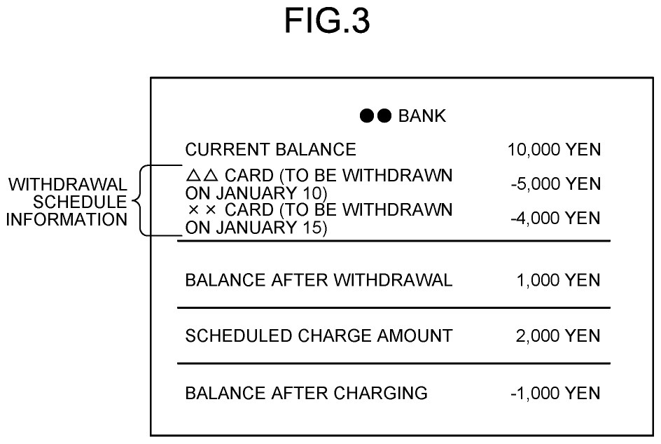

The display control unit 311 controls display contents on the operation/display unit 34. On the basis of operation of the user (touch operation, flick operation, and the like), the display control unit 311 displays predetermined information on the operation/display unit 34. Examples of the information displayed on the operation/display unit 34 by the display control unit 311 include a member registration screen for the user to register as a member of the wallet system, a login screen for the user to log in to the wallet system, a charge screen for the user to charge electronic money to the wallet, and a display screen of alert information (see, for example, FIG. 3).

The charge processing unit 312 charges (deposits) electronic money to the wallet. On the basis of operation of the user, the charge processing unit 312 outputs, to the wallet server 1, a charge request for charging electronic money to the wallet by a charging method registered (associated) in advance. Note that the “charging method” refers to a method for charging electronic money to the wallet serving as a virtual deposit/withdrawal account.

Examples of the charging method include a bank account and a credit card. A plurality of charging methods may be registered, and electronic money may be charged by any of the charging methods. Note that, in the present disclosure, description will be made on the assumption that a bank account is registered as the charging method.

The control unit 11 of the wallet server 1 that has acquired the charge request from the charge processing unit 312 on the basis of the operation of the user increases a balance of electronic money in the wallet on the basis of charge amount information included in the charge request. That is, the control unit 11 updates the wallet information 132 stored in the storage unit 13 in accordance with the increase in the balance of electronic money in the wallet. The control unit 11 then outputs information that charging to the wallet is completed (hereinafter referred to as “charge completion information”) to the user terminal 3. The control unit 11 also outputs a payment request of an amount corresponding to a charge amount to the settlement provider server 2 managing the bank account registered by the user as the charging method.

Here, the charge processing unit 312 may charge electronic money to the wallet from the bank account registered in advance within a range not exceeding a current balance of the bank account. On the other hand, even if an amount of electronic money to be charged from the bank account (hereinafter referred to as “scheduled charge amount”) does not exceed the current balance of the bank account, the amount may exceed a future balance of the bank account. That is, a balance of the bank account may become insufficient after charging considering, in addition to the charging to the wallet, an amount to be withdrawn in the future (hereinafter referred to as “scheduled withdrawal amount”) from the bank account registered as the charging method. Thus, the charge processing unit 312 notifies the user when a balance of the bank account serving as a charge source is expected to become insufficient after the charging of electronic money.

Specifically, when charging electronic money from the bank account registered in advance to the electronic wallet, the charge processing unit 312 acquires withdrawal schedule information 231 including a future scheduled withdrawal amount in the bank account from the settlement provider server 2 managing the bank account. The withdrawal schedule information 231 may be acquired from the settlement provider server 2 managing the bank account serving as a withdrawal destination, or may be acquired from the settlement provider server 2 managing a credit card or the like serving as a withdrawal source.

Subsequently, the charge processing unit 312 calculates a balance after withdrawal by subtracting the scheduled withdrawal amount from the current balance of the bank account. Then, when the balance after withdrawal is less than the scheduled charge amount, the charge processing unit 312 displays alert information through the display control unit 311 on the operation/display unit 34.

Examples of the alert information to be displayed on the operation/display unit 34 include, as illustrated in FIG. 3, a current balance of the bank account, a name of a withdrawal source, a withdrawal date, a scheduled withdrawal amount, a balance after withdrawal, a scheduled charge amount, and a balance after charging. Note that FIG. 3 illustrates an example in which the balance after withdrawal is 1,000 yen less than the scheduled charge amount.

In this way, by displaying alert information on the operation/display unit 34 when the balance of the bank account serving as the charge source is expected to become insufficient, the user may be informed of a future insufficient balance of the bank account. Note that, when the user sees alert information as illustrated in FIG. 3, for example, the user performs operation such as suspending charging from the bank account or performing charging from another bank account different from the bank account.

Here, when the balance after withdrawal is less than the scheduled charge amount (see, for example, FIG. 3), the charge processing unit 312 may perform charging using, as the charge source, another bank account (hereinafter referred to as “second bank account”) different from the original bank account (hereinafter referred to as “first bank account”). Note that the “second bank account” indicates a bank account registered as the charging method in advance separately from the first bank account.

When determining that the balance after withdrawal is less than the scheduled charge amount, the charge processing unit 312 interrupts charging from the first bank account and automatically charges electronic money to the wallet from the second bank account. In this way, by performing charging from the second bank account different from the first bank account when the balance of the first bank account serving as the charge source is expected to become insufficient, a future insufficient balance of the first bank account and a future mistake in withdrawal may be prevented.

In addition, when the balance after withdrawal is less than the scheduled charge amount (see, for example, FIG. 3), the charge processing unit 312 may change the charge source of the charging already executed. In this case, when determining that the balance after withdrawal is less than the scheduled charge amount and electronic money has been charged to the wallet from the first bank account, the charge processing unit 312 refunds an amount equivalent to the charged electronic money to the first bank account and charges electronic money to the wallet from the second bank account. In this way, by changing the charge source to the second bank account different from the first bank account when the balance of the first bank account serving as the charge source is expected to become insufficient, a future insufficient balance of the first bank account and a future mistake in withdrawal may be prevented.

In addition, when the balance after withdrawal is less than the scheduled charge amount (see, for example, FIG. 3), the charge processing unit 312 may receive lending of electronic money from a wallet held by another user. In this case, when determining that the balance after withdrawal is less than the scheduled charge amount, the charge processing unit 312 acquires electronic money equivalent to the scheduled charge amount from another wallet registered in advance (hereinafter referred to as “lending wallet”). Note that the lending wallet is, for example, a wallet managed by a family member or a friend. In this way, by acquiring electronic money from the lending wallet different from the wallet of the user when the balance of the bank account serving as the charge source is expected to become insufficient, a future insufficient balance of the bank account and a future mistake in withdrawal may be prevented.

In addition, when receiving lending of electronic money from the lending wallet, the charge processing unit 312 may acquire the electronic money within a range of a preset amount (hereinafter referred to as “lending amount”). That is, when the “lending amount” is equal to greater than the scheduled charge amount, the charge processing unit 312 acquires electronic money equivalent to the scheduled charge amount from the lending wallet. In addition, when the “lending amount” is smaller than the scheduled charge amount, the charge processing unit 312 acquires electronic money equivalent to the lending amount from the lending wallet. In this way, by setting a limit on the lending amount from the lending wallet, excessive borrowing of electronic money may be prevented.

In addition, when receiving lending of electronic money from the lending wallet, the charge processing unit 312 may pay back the lent electronic money after a preset period (hereinafter referred to as “lending period”). That is, when acquiring electronic money from the lending wallet, after a lapse of the lending period, the charge processing unit 312 remits, from the original wallet to the lending wallet, electronic money of the same amount as the electronic money acquired from the lending wallet. In this way, by specifying the lending period of electronic money, electronic money lent from the lending wallet may be surely collected.

The settlement processing unit 313 outputs, to the settlement provider server 2, a settlement request for settlement by using, for example, electronic money charged to the wallet or another settlement method (for example, a bank account or a credit card registered in advance).

The control unit 21 of the settlement provider server 2 that has acquired the settlement request from the user terminal 3 outputs the settlement request including a settlement amount to the wallet server 1 via the network NW. The control unit 11 of the wallet server 1 that has acquired the settlement request from the settlement provider server 2 reduces a balance of electronic money in the wallet of the user on the basis of the settlement amount included in the settlement request, and outputs updated wallet information 132 and settlement information 133 to the user terminal 3.

The storage unit 33 stores data of various screens displayed by the display control unit 311 on the operation/display unit 34. The storage unit 33 also stores the user information 131, the wallet information 132, the settlement information 133, and the like as needed.

The operation/display unit 34 includes a touch panel display, for example, and has an input function for accepting operation by a finger of the user, a pen, or the like, and a display function for displaying various types of information under control of the display control unit 311.

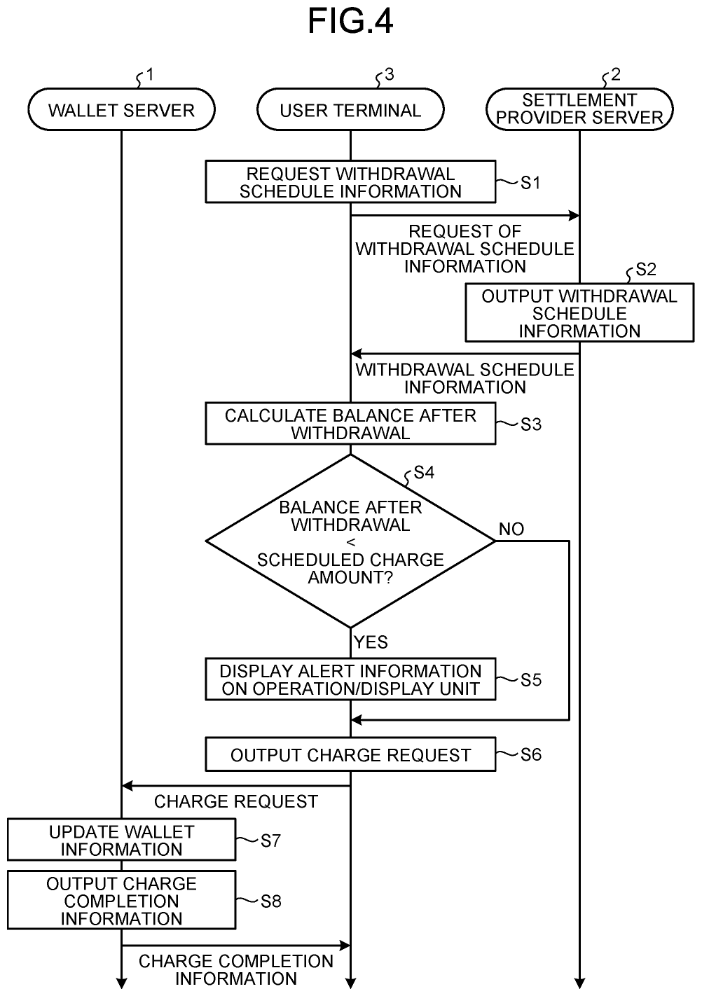

Hereinafter, an example of a method of charging electronic money executed by the wallet system according to the embodiment will be described with reference to FIG. 4. Note that the flowchart of FIG. 4 starts, for example, when a user performs operation such as “charging” on the charge screen displayed on the operation/display unit 34.

First, the charge processing unit 312 of the user terminal 3 requests the settlement provider server 2 for the withdrawal schedule information 231 (Step S1). In response to this, the control unit 21 of the settlement provider server 2 outputs the withdrawal schedule information 231 to the user terminal 3 (Step S2).

Subsequently, the charge processing unit 312 calculates a balance after withdrawal by subtracting a scheduled withdrawal amount from a current balance of a bank account (Step S3). Subsequently, the charge processing unit 312 determines whether or not the balance after withdrawal is less than a scheduled charge amount (Step S4).

When determining that the balance after withdrawal is less than the scheduled charge amount (Yes in Step S4), the charge processing unit 312 displays alert information (see, for example, FIG. 3) through the display control unit 311 on the operation/display unit 34 (Step S5). On the other hand, when determining that the balance after withdrawal is equal to or greater than the scheduled charge amount (No in Step S4), the charge processing unit 312 outputs, to the wallet server 1, a charge request for charging electronic money to the wallet (Step S6).

Subsequently, the control unit 11 increases a balance of electronic money in the wallet on the basis of charge amount information included in the charge request, and updates the wallet information 132 in accordance with the increase (Step S7). Subsequently, the control unit 11 outputs charge completion information to the user terminal 3 (Step S8). With this operation, this flow ends.

As described above, according to the mobile terminal, the wallet program, and the wallet system according to the embodiment, by displaying alert information on the operation/display unit 34 when a balance of a bank account serving as a charge source is expected to become insufficient, a user may be informed of a future insufficient balance of the bank account. Thus, user convenience may be improved.

Further effects and modifications may be easily derived by a person skilled in the art. Accordingly, broader aspects of the present disclosure are not limited to the particular details and the representative embodiment expressed and described above. Therefore, various changes are possible without departing from the spirit or scope of the general inventive concept as defined by the appended claims and equivalents thereof.

For example, in the mobile terminal, the wallet program, and the wallet system according to the embodiment, when it is determined that a balance after withdrawal is less than a scheduled charge amount, alert information is displayed on the operation/display unit 34. However, at the time of determination, a threshold may be set. In this case, when determining that an amount obtained by subtracting a preset amount (threshold) from the balance after withdrawal is less than the scheduled charge amount, the charge processing unit 312 displays alert information on the operation/display unit 34. With this configuration, when a balance of a bank account serving as a charge source is expected to become insufficient, a user may be informed of a future insufficient balance of the bank account earlier.

According to the present disclosure, user convenience may be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal comprising:
a display; and
a processor comprising hardware, the processor being configured to
acquire, when electronic money is deposited into a first electronic wallet from a first bank account registered in advance, information regarding a future scheduled withdrawal amount in the first bank account from a server managing the first bank account, and
control the display to display alert information when a balance after withdrawal obtained by subtracting the scheduled withdrawal amount from a current balance of the first bank account is less than a scheduled deposit amount indicating an amount of electronic money to be deposited from the first bank account.

2. The mobile terminal according to claim 1, wherein the alert information includes the current balance of the first bank account, the scheduled withdrawal amount, the balance after withdrawal, and the scheduled deposit amount.

3. The mobile terminal according to claim 1, wherein the processor is configured to deposit electronic money into the first electronic wallet from a second bank account different from the first bank account when the balance after withdrawal is less than the scheduled deposit amount.

4. The mobile terminal according to claim 1, wherein, when the balance after withdrawal is less than the scheduled deposit amount and electronic money is deposited into the first electronic wallet from the first bank account, the processor is configured to refund an amount equivalent to the deposited electronic money to the first bank account, and deposit electronic money into the first electronic wallet from a second bank account different from the first bank account.

5. The mobile terminal according to claim 1, wherein, when the balance after withdrawal is less than the scheduled deposit amount, the processor is configured to acquire electronic money equivalent to the scheduled deposit amount from a second electronic wallet registered in advance.

6. The mobile terminal according to claim 5, wherein the processor is configured to acquire the electronic money from the second electronic wallet within a range of a preset amount.

7. The mobile terminal according to claim 5, wherein, when electronic money is acquired from the second electronic wallet, after a lapse of a preset period, the processor is configured to remit, from the first electronic wallet to the second electronic wallet, electronic money of a same amount as the electronic money acquired from the second electronic wallet.

8. A non-transitory computer-readable recording medium on which an executable program is recorded, the program causing a processor of a computer to execute:
acquiring, when electronic money is deposited into a first electronic wallet from a first bank account registered in advance, information regarding a future scheduled withdrawal amount in the first bank account from a server managing the first bank account; and
controlling a display included in a mobile terminal to display alert information when a balance after withdrawal obtained by subtracting the scheduled withdrawal amount from a current balance of the first bank account is less than a scheduled deposit amount indicating an amount of electronic money to be deposited from the first bank account.

9. The non-transitory computer-readable recording medium according to claim 8, wherein the alert information includes the current balance of the first bank account, the scheduled withdrawal amount, the balance after withdrawal, and the scheduled deposit amount.

10. The non-transitory computer-readable recording medium according to claim 8, wherein the program causes the processor to execute depositing electronic money into the first electronic wallet from a second bank account different from the first bank account when the balance after withdrawal is less than the scheduled deposit amount.

11. The non-transitory computer-readable recording medium according to claim 8, wherein the program causes the processor to execute, when the balance after withdrawal is less than the scheduled deposit amount and electronic money is deposited into the first electronic wallet from the first bank account, refunding an amount equivalent to the deposited electronic money to the first bank account, and depositing electronic money into the first electronic wallet from a second bank account different from the first bank account.

12. The non-transitory computer-readable recording medium according to claim 8, wherein the program causes the processor to execute acquiring, when the balance after withdrawal is less than the scheduled deposit amount, electronic money equivalent to the scheduled deposit amount from a second electronic wallet registered in advance.

13. The non-transitory computer-readable recording medium according to claim 12, wherein the program causes the processor to execute acquiring the electronic money from the second electronic wallet within a range of a preset amount.

14. The non-transitory computer-readable recording medium according to claim 12, wherein the program causes the processor to execute , when electronic money is acquired from the second electronic wallet, after a lapse of a preset period, remitting, from the first electronic wallet to the second electronic wallet, electronic money of a same amount as the electronic money acquired from the second electronic wallet.

15. A wallet system comprising:
a server comprising a first processor comprising hardware, the first processor being configured to manage a first bank account; and
a mobile terminal comprising
a display, and
a second processor comprising hardware, the second processor being configured to
acquire, when electronic money is deposited into a first electronic wallet from a first bank account registered in advance, information regarding a future scheduled withdrawal amount in the first bank account from the server, and
control the display to display alert information when a balance after withdrawal obtained by subtracting the scheduled withdrawal amount from a current balance of the first bank account is less than a scheduled deposit amount indicating an amount of electronic money to be deposited from the first bank account.

16. The wallet system according to claim 15, wherein the alert information includes the current balance of the first bank account, the scheduled withdrawal amount, the balance after withdrawal, and the scheduled deposit amount.

17. The wallet system according to claim 15, wherein the second processor is configured to deposit electronic money into the first electronic wallet from a second bank account different from the first bank account when the balance after withdrawal is less than the scheduled deposit amount.

18. The wallet system according to claim 15, wherein, when the balance after withdrawal is less than the scheduled deposit amount and electronic money is deposited into the electronic wallet from the first bank account, the second processor is configured to refund an amount equivalent to the deposited electronic money to the first bank account, and deposit electronic money into the first electronic wallet from a second bank account different from the first bank account.

19. The wallet system according to claim 15, wherein, when the balance after withdrawal is less than the scheduled deposit amount, the second processor is configured to acquire electronic money equivalent to the scheduled deposit amount from a second electronic wallet registered in advance.

20. The wallet system according to claim 19, wherein the second processor is configured to acquire the electronic money from the second electronic wallet within a range of a preset amount.
